(19) United States
(12) Patent Application Publication
(10) Pub. No.: US 2013/0080968 A1
(43) Pub. Date: Mar. 28, 2013

(54) USER INTERFACE WITH MEDIA CONTENT PREDICTION

(71) Applicants: Matthew J. Hanson, Issaquah, WA (US); Timothy A. Gilman, Sumner, WA (US); Gerald A. Hamrock, San Jose, CA (US); Anil Kumar Kalagatla, Lynnwood, WA (US); Peter A. Larsen, Seattle, WA (US); David A. Limp, Medina, WA (US); Joseph J. Muhm, Seattle, WA (US); Nanyan Nicholls, Seattle, WA (US); Amir Pelleg, Seattle, WA (US); Charles P. Vaughn, Seattle, WA (US); Srinivas Visvanathan, Redmond, WA (US)

(72) Inventors: Matthew J. Hanson, Issaquah, WA (US); Timothy A. Gilman, Sumner, WA (US); Gerald A. Hamrock, San Jose, CA (US); Anil Kumar Kalagatla, Lynnwood, WA (US); Peter A. Larsen, Seattle, WA (US); David A. Limp, Medina, WA (US); Joseph J. Muhm, Seattle, WA (US); Nanyan Nicholls, Seattle, WA (US); Amir Pelleg, Seattle, WA (US); Charles P. Vaughn, Seattle, WA (US); Srinivas Visvanathan, Redmond, WA (US)

(73) Assignee: Amazon Technologies Inc.

(21) Appl. No.: 13/429,218

(22) Filed: Mar. 23, 2012

Related U.S. Application Data
(60) Provisional application No. 61/539,940, filed on Sep. 27, 2011.

(51) Int. Cl. G06F 3/048

(52) U.S. Cl. 715/783

(57) ABSTRACT

Some implementations include displaying media content items on a home screen of a computing device. A display order for a list of media content items may be determined based, at least in part, on a predicted likelihood that an individual one of the plurality of media content items will be selected. A home screen of a user interface may be displayed, according to the determined display order, with a list of a plurality of media content items that are available to the computing device.

### RELATED APPLICATIONS

This application claims the benefit of U.S. Provisional Application No. 61/539,940, filed Sep. 27, 2011, the entire contents of which are hereby incorporated by reference herein for all purposes.

### BACKGROUND

Handheld computing devices such as electronic book reader devices, smartphones, personal data assistants, personal media players, and tablet computers have begun to rival personal computers for versatility and functionality. Users of such devices are able to perform a multitude of functions such as checking email, browsing the internet, viewing videos, playing games, downloading applications, listening to music, and reading eBooks. Users find these devices handy for consuming media while commuting, travelling, or while just staying at home.

Many such devices have graphical user interfaces paired with touch screen input capability. A “home screen” or “start screen” of the device usually presents a collection of application icons. If a user desires to view media content, such as video or music content, the user launches the appropriate application and selects the content that he or she desires. To obtain new content, the user launches a web browser or a dedicated application for purchasing or discovering new content, and browses the selections available from various sources.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 shows a computing device with media content prediction according to embodiments.

FIG. 2 show illustrative home screens of a user interface in both a horizontal and a vertical layout with overlapping graphic tiles.

FIG. 3 show illustrative user interfaces in both a horizontal and a vertical layout with non-overlapping graphic tiles.

FIG. 4 shows an illustrative library screen according to embodiments.

FIGS. 5A-F shows illustrative graphic tiles according to various embodiments.

FIG. 6 shows an illustrative process for displaying a user interface with a list of media content files ordered according to selection likelihood prediction.

### DETAILED DESCRIPTION

### Overview

As noted above, conventional handheld computing devices have user interfaces (UI) that display start screens with application icons that are selectable to launch the associated applications. To select particular content—such as a particular electronic book, song, or video—the user launches the appropriate application and then selects the content that he or she desires.

Some examples herein describe a computing device, and a user interface (UI) for a computing device, that streamlines the process of accessing and obtaining media content. A home screen of the UI displays a list of media content items that are available to the device. The media content items may be audio files, video files, electronic books, web content, and so forth. Some of the media content items may also be an aggregate of other media content items, such as a playlist of songs, an album, or a television series. The media content items may be stored on the device or available to the device via a network connection. The list may include other things such as applications, widgets, profile information, and so forth. The UI presents the list in an order that is determined based on a prediction of how likely a user of the device is to select the individual media content items.

In embodiments, “recency” data may be used to predict how likely a user is to select content. Recency data may include a most recent access time, a most recent purchase time, a most recent download time, or other time-based data. Media content items with more recent accesses, purchases, downloads, etc. may be ordered nearer to the top of the list than are media content items with less recent accesses, purchases, downloads, etc. Predictions may also be made based on the recent availability of a media content item, even if the media content item is not available. In one example, a newly available television episode may be listed high in the list based on prior viewing of other episodes in the same television series, even if the newly available television episode has not been previously downloaded, accessed, or purchased.

In embodiments, only a portion of the list is viewable at any particular time, and the portion of the home or start screen that displays the list may be interactive to enable the user to browse the list and cause other portions of the list to be viewable. The UI may also present recommendations, related content, or other information to the user on the start screen based on the particular media content item that has user interface focus. For example, the UI may display links to related works or links to information about a work that has current user interface focus.

By including a list of media content items ordered based on a likelihood of user selection, the UI start screen makes it easier for the user to immediately select or discover desired content. Because multiple types of media content items are presented in an ordered list, the user does not need to open an application to view videos, and another application to read an electronic book. Rather, the user can immediately browse all of his or her media content items and choose the desired one directly from the start screen.

The present description uses the words “start screen” and “home screen” to describe a primary or default screen shown to users via a UI. In various embodiments, the home screen is the screen displayed after the user presses a “home” button or selects an analogous touch screen feature or after the device is powered on or woken up from a low-power state, either immediately after power-on or wake up or after an initial unlock screen(s) and/or start-up screen(s). A home screen may be the first screen in the UI hierarchy that allows the user to launch applications or content, and is typically the screen from which substantially all other functions are accessible, either directly or indirectly, without having to “back out” to a previous screen in the UI hierarchy.

The techniques and systems described herein may be implemented in a number of ways. Example implementations are provided below with reference to the following figures.

Illustrative Computing device

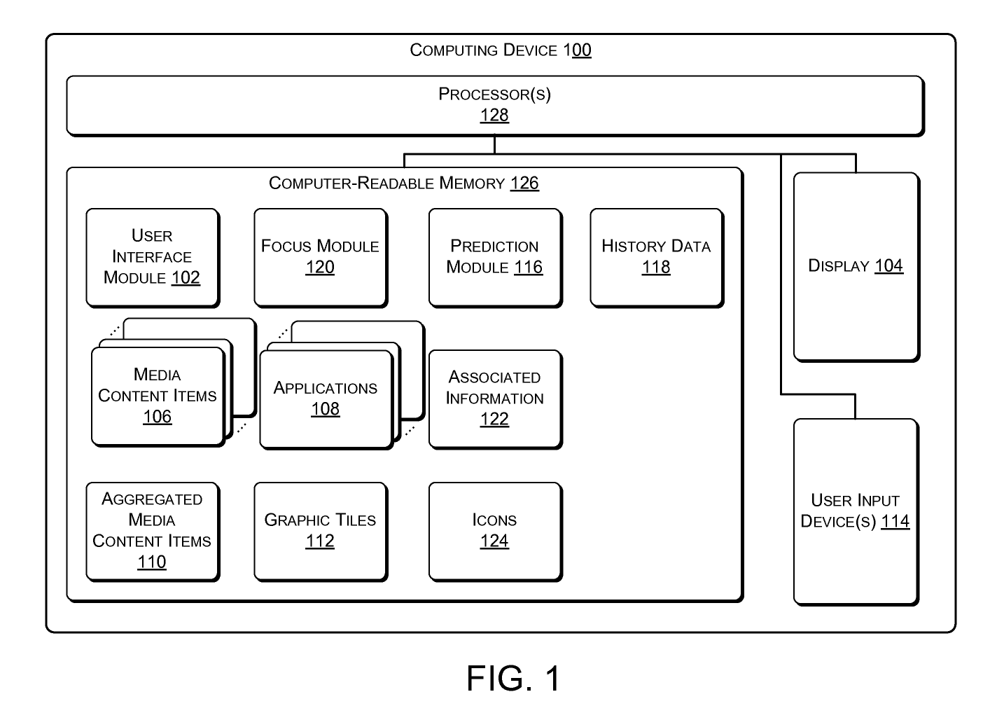

FIG. 1 shows a computing device 100 with media content prediction according to embodiments. A user interface module 102 causes display of a user interface (UI) 104, including a home screen on a display 106 of the computing device 100. The home screen—examples of which are illustrated in subsequent figures—includes a portion having a list, or a subset of a list, of a plurality of media content items 108 that are available to the computing device 100. In embodiments, the list may also include one or more applications 110 available to the computing device 100. The media content items 108 include media files stored on the computing device 100 and/or links to media files stored elsewhere and accessible to the computing device 100 via a network connection.

In various embodiments, the media content items 108 include one or more electronic books, videos (such as television episodes, movies, music videos, news segments, and others), blog content, web content, periodicals such as electronic versions of newspapers and magazines, and audio files (such as music files, audio book segments, and podcasts). In addition, the user interface module 102 is configured to display aggregated media content items 112 such as music albums, audio books, playlists, collections of television programs or television series, periodical subscriptions, aggregates of frequently accessed web or blog content, a most recently played songs list, and others. The user interface module 102 is configured to display other items in the list such as advertisements, promotional offers, special offers, content recommendations, user profile information/links, third party widgets, system settings/links, and so forth.

In embodiments, the user interface module 102 may display the list as a text listing of the content, including for example name and/or artist. In embodiments, the user interface module 102 may display the list as a series of graphic tiles 114 that are selectable to launch an appropriate one of the applications 110 to view, listen, or otherwise consume the corresponding one of the media content items 108. In embodiments, the graphic tiles 114 include “cover art” for the media content items 108. In embodiments, where one or more applications 110 are listed in the list, the graphic tiles 114 may resemble application icons. In embodiments where blog and/or web content are displayed in the list, the graphic tiles 114 may include website or blog logos and may include content taken from the blog or website. The graphic tiles 114 include, in various embodiments, the front page or cover of one or more periodicals. Where the list includes an aggregation of media content items, the graphical tiles 114 may include a graphical tile mosaic with two or more graphical tiles corresponding to some or all of the aggregated media content items may be displayed to represent two or more of the aggregated media content items.

The user interface module 102 is configured to accept user input from user input device(s) 116. In embodiments, the user input device(s) 116 may include a touch screen that overlays or is integrated with the display 106. The user input device(s) may include other types of input devices such as pointer devices, buttons, audio input devices, keyboards, and so forth. A user may use the input device(s) to tap on or otherwise select a graphical tile displayed within the list to download, purchase, access, and/or launch the content or underlying application associated with the tapped graphical tile.

As noted above, the user interface module 102 is configured in various embodiments to display only a portion of the list of the media content items 108 that are available to the computing device 100. In these embodiments, the user interface module 102 is configured to enable the portion of the home screen that includes the list to be interactive to cause display of additional ones of the plurality of media content items 108. A user may swipe through the list using a touch screen display or interact with the list using some other user input device type. The UI 104 may scroll through the list using animation such as by showing a sliding view of the available content. In embodiments, the list may be presented as a “carousel” that rotates either to the left or to the right (or up or down) depending on the received user input. The “carousel” may be looped, such that scrolling through the list of content media items to the end of the list results in a return to the beginning of the list. In embodiments, the “carousel” is not looped, such that scrolling to the end of the list does not result in a return to the beginning of the list.

A prediction module 118 is configured to determine an order of the list as it is presented by the user interface module 102. The prediction module 118 determines the order based at least on a prediction of a likelihood that the media content items 108 will be selected, such as by a user. The prediction module 118 is configured, in embodiments, to predict the likelihood of user interaction based on history data 120 associated with the individual ones of the media content items 108 and applications 110. The history data 120 may include, among other things, recency data associated with the times of most recent download, access, and/or purchase of the various media content items 108 and applications 110. Recency data may be used to determine the order that the media content items 108 and the applications 110 appear in the list. In embodiments, the more recently an item has been downloaded, accessed, or purchased, the closer the item is to the top of the display order. In embodiments, the most recent of the purchase, download, or access of a particular item is used to determine its place in the display order.

In embodiments, the prediction module 118 compares absolute times to determine the display order; in other embodiments, durations since the most recent access, download, or purchase are used by the prediction module 118 to determine the display order. In embodiments, the history data 120 may include an aggregate recency score or metric, such as an average of two or more of the purchase, download, and access times, or an average of the times elapsed since two or more of the purchase, download, and access times. In embodiments, an aggregate recency score or metric may apply various weightings to the purchase, download, and access times. Other recency data may also be used, such as time of nth access, download, and/or purchase.

In one example, an electronic book was purchased three months ago and downloaded 45 minutes ago. A movie was purchased 80 minutes ago and downloaded 10 minutes ago. Meanwhile, web content was viewed 30 minutes ago. In this example, the prediction module 118 predicts that the user will be most likely to select the movie (downloaded 10 minutes ago), second most likely to select web content (accessed 30 minutes ago), and third most likely to select the electronic book (downloaded 45 minutes ago). In this example, the prediction module 118 causes the user interface module 102 to display the list of media content items 108 with the movie higher in the list than the web content, which is itself higher in the list than the electronic book.

In embodiments, the prediction module 118 uses recency data to predict how likely an aggregated media content item is to be selected. In one example, the prediction module 118 may use the most recent time that that an audio file or a video file was placed into an active play queue in order to predict how likely the “now playing” aggregated media content item is to be selected.

In embodiments, other factors besides recency data are used to determine the order. In embodiments, the prediction module 118 predicts that there is relatively high likelihood that content available to the computing device 100 (but not previously purchased, downloaded, or accessed on the computing device 100) will be selected based on the previous purchases, downloads, or accesses of related content. In one example, if a user has previously accessed periodical content, the prediction module 118 may predict that the user is relatively likely to select a newly available issue from the same periodical. This may occur, for example, where the user subscribes to the periodical content and the newly available issue is therefore available to the computing device 100 without additional purchase due to the subscription. In another example, where a user has previously downloaded or accessed television episodes, the prediction module 118 may predict that the user is relatively likely to select a newly available television episode that comes from the same television series as do the previously viewed episodes. Based on the user's history in previously accessing the related content, the prediction module 118 may place the newly available content higher or lower in the list. In one example, the prediction module 118 may determine that a user is more likely to view a first newly available television episode if the user has previously viewed 20 episodes of the corresponding television series, and less likely to view a second newly available television episode of a different series if the user has viewed only two previous episodes of the other series. In this example, the prediction module 118 may order the list such that the first television episode is closer to the top of the list than is the second television episode.

In still further embodiments, the prediction module 118 predicts the likelihood of selection based on previous user selection of similar media content items, or based on time-of-day, day-of-week, time-of-month, location data, or other data within history data 120.

The user interface module 102 is also configured to display a second portion of the UI 104, different from the list of the media content items 108, on the home screen. In embodiments, the second portion may include application icons to launch one or more of the applications 110. The second portion may be a “ribbon” showing a group of icons. The list of application icons that are in the second portion may be configurable by the user, so that the user can select those applications that he or she wants to access from the home screen. For example, in a separate screen listing the applications 110, the icons for each application can be selected (such as with a tap-and-hold user input) to place the applications in the bottom ribbon portion. In embodiments, one or more of the application icons in the second portion may be based on recency data, such that the most recently accessed applications have icons in the second portion. In embodiments, recently accessed documents (such as spreadsheets, word processing documents, text documents, or portable document format (PDF) documents) may be shown in the second portion.

The one or more icons in the second portion may be included on one or more “shelves” that are viewable on the home screen. One or more shelves may be available “off screen” thus requiring user input, such as a swipe on a touch screen, to cause the additional shelves to become viewable on the home screen. In embodiments, one or more of the icons in the second portion of the UI 104 may be determined based on a particular media content item in the list that has current user interface focus. A focus module 122 may determine which media content item has focus. Focus may be determined based on the user input to select the media content item (such as by tapping or clicking on it). Focus may be determined by user input to scroll through the list thereby causing some item in the list to be given UI focus. Based on the item in the list with UI focus, the focus module 122 may cause the user interface module 102 to display associated information 124 that corresponds to the item with user interface focus. The corresponding associated information 124 may be displayed in the form of icons 126 within the second portion of the home screen.

The associated information 124 includes, in embodiments, links to purchase or download recommendations such as content that is similar to the item with focus or selections of media content items that have been purchased or downloaded by other users (using for example other devices) who have also purchased, downloaded, and/or accessed the item with focus. The associated information 124 includes, in embodiments, links to related content available to the computing device 100 (i.e., content that is similar to the item with focus and that is already available without making further purchase; this may include content that has already been purchased or downloaded, and it may include content that is available to the user for free such as through an existing subscription). The associated information 124 may include links to artist or media information stored on the computing device 100. The associated information may include links to artist or media information available to the computing device 100 via a network connection, such as via the internet. The icons displayed in the second portion may include graphics that identify the source of the artist or media information (such as the website where the content resides.) The associated information 124 includes links to other issues of periodicals, other episodes of television series, other content by the same artist, and so forth. The associated information 124 includes links to content already stored or otherwise available to computing device 100, and other links that are selectable to purchase content not currently available to computing device 100.

The associated information 124 may include links to “extras” such as “behind the scenes” videos, text descriptions of the content and/or artist, photos related to the media item with focus, or other content related to the media content item with focus. When a playlist item has UI focus, an icon associated with a currently playing audio or video file may be displayed in the second portion. In embodiments, the associated information 124 includes links to application details when an application has UI focus.

In embodiments, when the item in the list with UI focus is an aggregated web content item, the focus module 122 causes the user interface module 102 to display links to recently viewed web pages. The icons shown in the second portion of the home page may include web page logos or a thumbnail of the most recently viewed web content, or dynamically generated to show the current web content (such as the content of a home page of the website linked to).

The icons used may be generic icons (such as “artist information icons” or “currently playing song”). In other embodiments, the icons may be based on cover art, or be branded logos representing the source the information. The icons may also include, either within the logo itself or placed near it, text information that provides additional information about the link associated with the icon. In some examples, the text may state “website” to indicate that the icon is a link to a website, or “movie info” to indicate that the icon is a link to information about a movie that has current UI focus in the list.

The user interface module 102 is configured to display links to content libraries on the home screen. For example, there may be links to a video library including links to the videos available to the computing device 100, a music library including links to the music files available to the computing device 100, an electronic book library including links to the electronic books available to the computing device 100, a blog library including links to previously accessed blogs, a web library including links to previously accessed web pages, and so on. In addition, the user interface module 102 is configured to display a “store” link that enables a user of the device to search for and purchase content for consumption on the computing device 100.

As noted above, the media content items 108 are listed on the home screen using graphic tiles taken from the graphic tiles 114. In various embodiments, graphic tiles are displayed with dynamic content. The dynamic content may be displayed as part of a “badge” graphic that overlays a portion of the graphic tile, such as a graphic tile associated with an electronic book. The badge graphic may resemble a bookmark or other graphic. According to various embodiments, the dynamic content includes one or more of: a percent or number of pages of an electronic book previously read (i.e., accessed previously by the computing device 100), a percent or pages remaining to be read in an electronic book (i.e., not yet accessed by the computing device 100), the number of highlights or notes made to the copy of an electronic book on the computing device 100, a personal rating given the media content item by a user of the computing device 100, a most recently accessed portion of the media content item on the computing device 100, (such a name or number of a current chapter or page of an electronic book (e.g., the chapter or page that was most recently accessed)), a synopsis of the media content item, an artist name, character names associated with the media content item (such as in an electronic book, movie, television program, or audio book), quotes from the media content item, song lyrics from a song, social media information associated with the media content item (such as a number of “likes” and/or mentions of the media content item in a social media context), social media discussion content related to the media content item, links to social media information associated with the media content item (such as links to a social media page for the media content item), portions of an electronic book commonly highlighted by other users, review content associated with the media content item, and an indication of a sales rank or bestseller status for the media content item. The dynamic badge content may include a download progression. The dynamic badge content may be animated or static. Other examples of dynamic content are possible without departing from the scope of the present application.

In embodiments, the user interface module 102 is configured to adjust the orientation of the home screen (and other screens) displayed on the display 106 based on an orientation of the computing device, such as may be determined by an accelerometer device on the computing device 100. The interactive list showing the media content items 108 and applications 110 available to the computing device 100 and/or the second portion showing application icons or links to associated information 124 may be adjusted to suit the particular orientation of the display (horizontal or vertical). In embodiments, the second portion of the home screen may not be visible on the home screen in an initial view in certain orientations, such as in a horizontal orientation.

In embodiments, computer-readable memory 128 may include volatile memory (such as RAM), nonvolatile memory, removable memory, and/or non-removable memory, implemented in any method or technology for storage of information, such as computer-readable instructions, data structures, program modules, or other data. Also, the processor(s) 130 may include onboard memory in addition to or instead of the computer-readable memory 128. Some examples of storage media that may be included in the computer-readable memory 128 and/or processor(s) 130 include, but are not limited to, random access memory (RAM), read only memory (ROM), electrically erasable programmable read only memory (EEPROM), flash memory or other memory technology, compact disk (CD-ROM), digital versatile disks (DVD) or other optical storage, magnetic cassettes, magnetic tape, magnetic disk storage or other magnetic storage devices, or any other medium usable to store the desired information and that can be accessed by the computing device 100. Any such computer-readable media may be part of the computing device 100.

The computer-readable memory 128, meanwhile, may include software programs or other executable modules that may be executed by the processor(s) 130. Examples of such programs or modules include control modules (e.g., power management), network connection software, an operating system, sensor algorithms, and so forth. The computer-readable memory 128 may also be used to store various databases.

Various processes, instructions, methods and techniques described herein may be considered in the general context of computer-executable instructions, such as program modules, that are executable by one or more computers or other devices. Generally, program modules include routines, programs, objects, components, data structures, etc. for performing particular tasks or implementing particular abstract data types. These program modules can be implemented as software modules that are executable on the processor(s) 130, as hardware, and/or as firmware. Typically, the functionality of the program modules may be combined or distributed as desired in various embodiments. An implementation of these modules and techniques may be stored on or transmitted across some form of computer-readable media.

The modules stored in computer-readable memory 128 may be implemented across one or more servers in a cloud computing environment, on a local device, or on a combination of both. The following discussion does not limit the implementation of the modules stored in computer-readable memory 128 to any particular device or environment.

### Illustrative User Interfaces

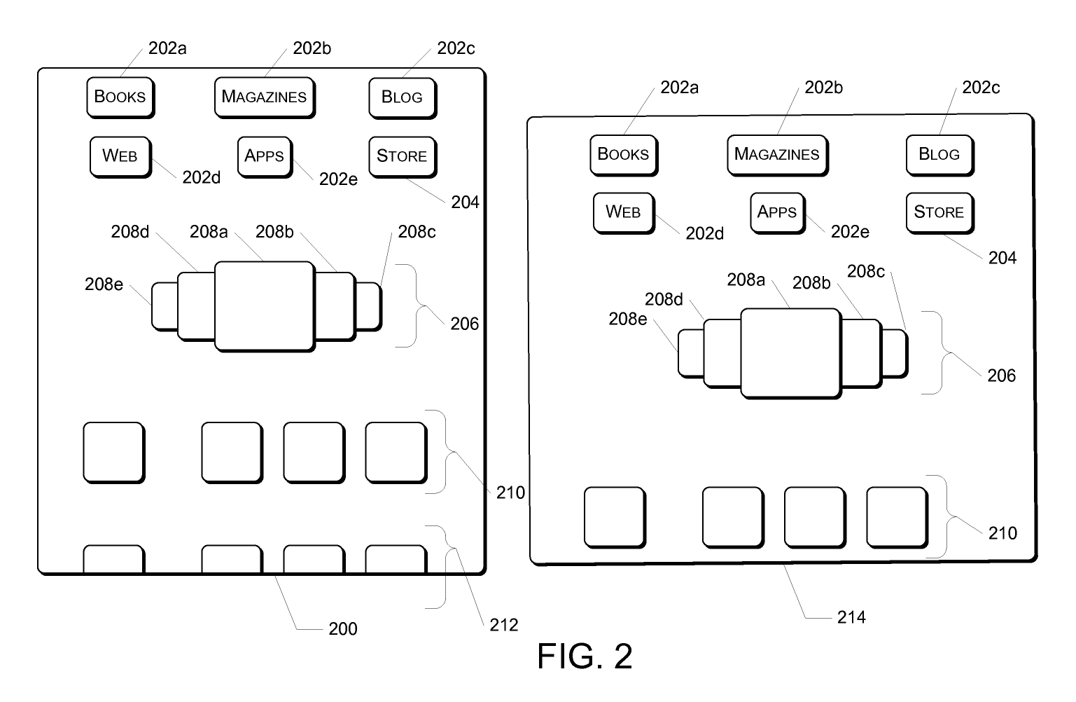

FIGS. 2A and 2B show illustrative home screens 200 and 214 of a user interface in both a horizontal and a vertical layout with overlapping graphic tiles. The home screens 200 and 214 are described with reference to FIG. 1. The home screen 200 includes library links 202a-e that link to various media content libraries and application libraries available to a computing device, such as to the computing device 100. The home screen 200 includes a “store” link 204 that is selectable to view a store interface screen from which new media content can be discovered, sampled, and purchased.

A list portion 206 of the home screen 200 includes several overlapping graphic tiles 208. Graphic tile 208a is displayed front-and-center, and is displayed larger than the other graphic tiles 208b-e. In alternative embodiments, the graphic tiles 208b-e may be displayed the same or larger size than graphic tile 208a. The list portion 206 of the home screen 200 is interactive, as is described elsewhere within this Detailed Description, to allow the list of media content items to be browsed. In the example shown in FIG. 2, a swipe to the right may show additional graphic tiles that represent additional media content items. A swipe to the left may show other graphic tiles. In an initial configuration, the “front-and-center” graphic tile may represent the media content item that is first in the display order, such as is determined by prediction module 118. In embodiments, the list portion 206 may be linear, such that the overlapping graphic tiles 208 in the list have a first tile (representing the top of the display order) and last tile (representing the bottom of the display order).

The graphic tiles 208 are selectable to launch the corresponding media content item and the associated application. Where graphic tiles 208 represent applications, selecting the graphic tiles launches the underlying application.

A ribbon portion 210 includes icons arranged in a row. A second ribbon portion 212 is shown below the ribbon portion 210, and is only partially visible. The home screen may be scrolled upwards, such as by swipe input, to fully display the second ribbon portion 212. Other ribbon portions may also be available beneath the second ribbon portion 212, and further scrolling of the home screen may make them visible.

In embodiments, one or more of these icons in the various ribbon portions are links to applications on the computing device. In other embodiments, the icons may be selected based on a particular one of the graphic tiles 208 that has user interface focus. In embodiments, the icon with focus may be displayed enlarged, or with a highlighted border, or with some other indication that it has focus. For example, the “front-and-center” graphic tile 208a as shown in FIG. 2 may have user interface focus, and various ones of the icons shown in the ribbon portion 210 and/or the second ribbon portion 212 may be selected by a focus module, such as focus module 122, based on the fact that the graphic tile 208a has user interface focus. Such icons may include links to artist or media information, related content, recommended content, similar items, and so forth as is described elsewhere within this Detailed Description. In embodiments, other ones of the graphic tiles 208 may be given user interface focus, such as by selection of the graphic tiles or by scrolling through the list portion 206.

Home screen 214 of FIG. 2B shows home screen 200 in a horizontal orientation. Second ribbon portion 212 is not visible in home screen 214, although the home screen 214 may be scrollable to view second ribbon potion 212, and any other ribbon portions that are available.

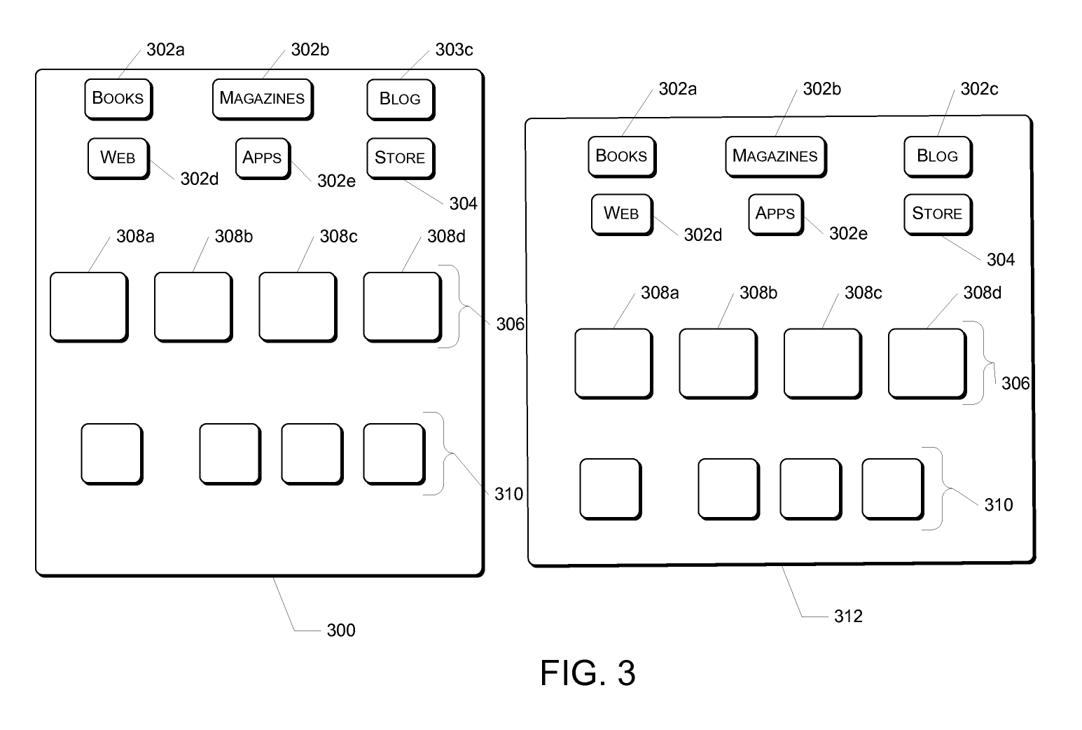

FIG. 3A show illustrative home screens 300 and 312 of a user interface in both a horizontal and a vertical layout with non-overlapping graphic tiles. The home screens 300 and 312 are described with reference to FIGS. 1 and 2. The home screen 300 includes library links 302a-e to various media content libraries and application libraries available to a computing device, such as to the computing device 100. The home screen 300 includes a “store” link 304 that is selectable to view a store interface screen from which new media content can be discovered, sampled, and purchased.

A list portion 306 includes several non-overlapping graphic tiles 308a-d. The list portion 306 of the home screen 300 is interactive, as is described elsewhere within this Detailed Description, to allow the user to browse through the list of media content items. In the example shown in FIG. 3, a swipe to the right may show additional graphic tiles that represent additional media content items. A swipe to the left may show other graphic tiles. In an initial configuration, the left-most graphic tile may represent the media content item that is first in the display order, such as is determined by prediction module 118. In embodiments, the list portion 306 may be linear, such that the viewable non-overlapping graphic tiles 308 have a beginning (representing the top of the display order) and an end (representing the bottom of the display order).

The graphic tiles 308 are selectable to launch the corresponding media content item and the associated application usable to render or access the media content item. Where graphic tiles 308 represent applications, selecting the graphic tiles launches the underlying application.

A ribbon portion 310 includes icons arranged in a row. The home screen 300 may be scrolled upwards, such as by swipe input, to display other ribbon portions may also be available beneath the ribbon portion 310.

In embodiments, one or more of these icons in the various ribbon portions are links to applications on the computing device. In other embodiments, the icons may be selected based on a particular one of the graphic tiles 308 that has user interface focus. In embodiments, the icon with focus may be displayed as enlarged, or with a highlighted border, or with some other indication that it has focus. For example, the left-most graphic tile 308a as shown in FIG. 3 may have user interface focus, and various ones of the icons shown in the ribbon portion 310 may be selected by a focus module, such as focus module 122, based on the fact that the graphic tile 308a has user interface focus. Such icons may include links to artist or media information, related content, recommended content, similar items, and so forth as is described elsewhere within this Detailed Description. In embodiments, other ones of the graphic tiles 308 may have user interface focus, such as by selection of the graphic tiles or by scrolling through the list portion 306.

Home screen 312 of FIG. 3B shows home screen 300 in a horizontal orientation.

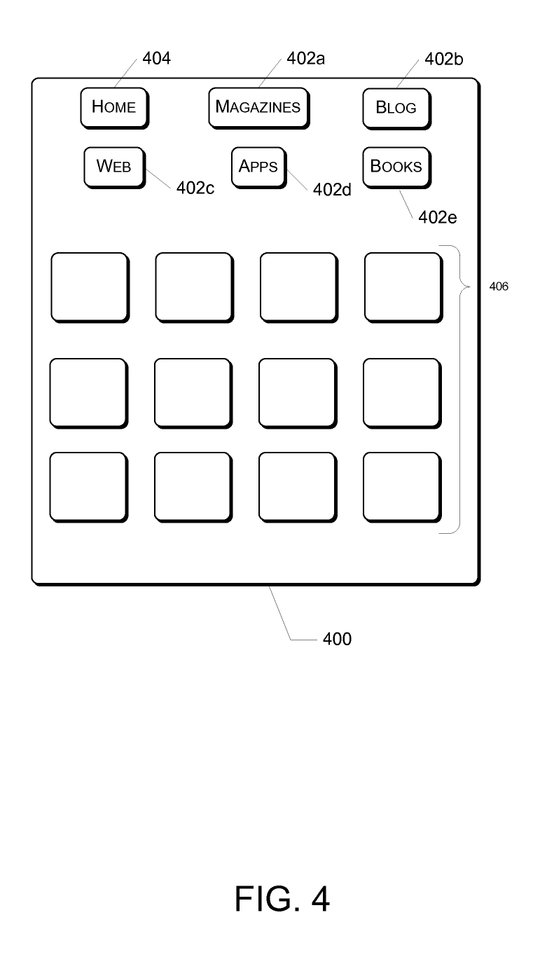

FIG. 4 shows an illustrative library screen 400 according to embodiments. The library screen 400 is described with reference to FIGS. 1-3. Library screen 400 illustrates an example library screen that is reachable from the various library icons 202 and 302 in FIGS. 2 and 3, respectively. Library screen 400 includes library links 402 which may be the same or different than library links 202 and 302. Home screen link 404 is selectable to return to the home screen, such as home screen 200, 214, 300, and 312.

Icons 406 are selectable to launch the application and/or media content item associated with the icon. For example, if the library screen 400 is a “book” library, the icons may display the cover art for the electronic books available to the computing device, and selecting the icons via the user interface opens the electronic books. Where the library screen 400 is an application library, the icons 406 are application icons that are selectable to launch the underlying applications.

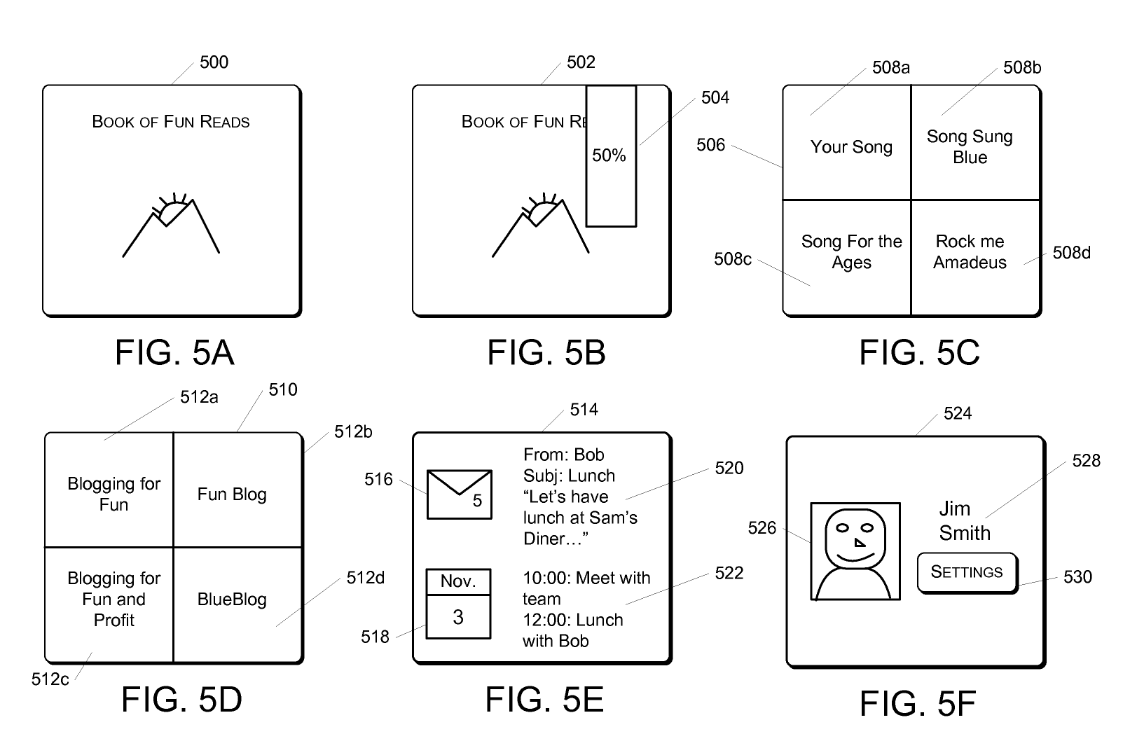

FIGS. 5A-F shows illustrative graphic tiles according to various embodiments. FIG. 5A shows an electronic book tile 500 showing cover art associated with the corresponding electronic book. FIG. 5B shows an electronic book tile 502 with badge 504. The bookmark may have dynamic content as described elsewhere within this Detailed Description.

FIG. 5C illustrates a graphic tile mosaic 506 representing aggregated songs, such as on a song playlist. The cover art 508a-d represents four different songs in the playlist and are positioned in the four quadrants of the graphic tile mosaic. The number of songs represented in graphic tile mosaics, such as in graphic tile mosaic 506, is not limited to the number of songs in the corresponding playlist.

FIG. 5D illustrates a graphic tile mosaic 510 representing blog content. In embodiments, blog logos 512a-d in the four quadrants of the graphic tile mosaic represent, collectively, blog content that is available to the computing device. Other embodiments may include thumbnails of the most recently accessed blog content, or thumbnails of a current state of the various blogs' home pages, or most recent posts.

FIG. 5E illustrates a productivity widget tile 514 that may be placed into the content carousel (or list portion) on the home screen according to embodiments. Email graphic 516 indicates that the number of emails (or unread emails), and calendar graphic 518 indicates the date. Area 520 includes email previews, and area 522 includes calendar appointment information. Productivity widgets with other layouts may be utilized according to various embodiments.

FIG. 5F illustrates a user profile tile 524 that may be placed into the content carousel (or list portion) on the home screen according to embodiments. The user profile tile 524 may include a user photo 526, a name 528, and a settings button 530 that is selectable to cause the UI to show various settings.

The preceding figures illustrated various user interface screens, icons, and graphic tiles. But other user interface screens, icons, and graphic tiles—and other arrangements of user interface screens, icons, and graphic tiles, may be used according to various embodiments to achieve the same or similar results.

Illustrative Process for Displaying Content with Likelihood Prediction

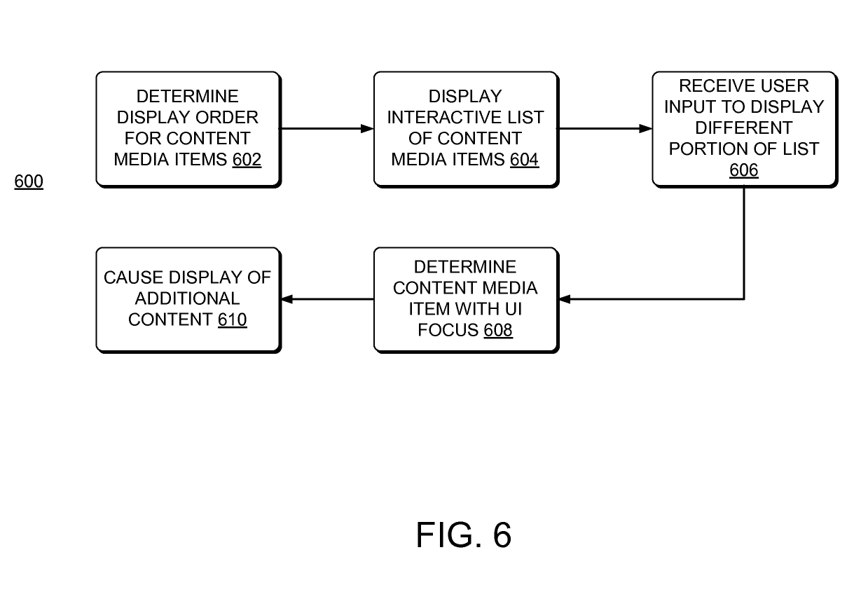

FIG. 6 shows an illustrative process 600 for displaying a user interface with a list of media content files ordered according to selection likelihood prediction. The process 600 is described with reference to the preceding figures, and specifically with reference to FIGS. 1-5. The process 600 is illustrated as a collection of blocks in a logical flow graph, which represent operations that can be implemented in hardware, software, or a combination thereof. In the context of software, the blocks represent computer-executable instructions that are executable by one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Also, one or more of the described blocks may be omitted without departing from the scope of the present disclosure.

At 602, a display order of a plurality of media content items available to a computing device is determined. The display order is based on a prediction by a prediction module, such as prediction module 118, of how likely individual ones of the plurality of media content items are to be selected. In one example, a prediction for a music file, or an active play queue, is based on how recently the music file or another music file has been added to the active play queue. In embodiments, predictions are based on recency data associated with the individual ones of the plurality of media content items as is described elsewhere within this Detailed Description. In embodiments, predictions are based on other data besides recency data.

At 604, a user interface module, such as user interface module 102, displays an interactive list of the plurality of media content items in a home screen of the UI based on the determined display order. In embodiments, the interactive list includes a sliding window that determines a portion of the interactive list that is viewable on a display of the computing device at a particular time.

At 606, instructions related to user input are received to display a different portion of the interactive list. In embodiments, the viewable items in the interactive list are encompassed by a sliding window, and the sliding window moves along the interactive list to a different location based on the user input. At this point, different media content items are encompassed by the sliding window, thereby causing those different media content items to be displayed in the home screen.

At 608, a focus module, such as focus module 122, determines a particular one of the media content items that has current UI focus. UI focus may be determined based on user selection of the item in the interactive list. Alternatively, or in addition to, UI focus may be determined based on the user input to view other portions of the interactive list, thereby causing a particular media content item to receive UI focus.

At 610, the focus module causes the user interface module to display additional content that is relevant to the particular one of the plurality of media content items that has UI focus. The additional content includes, in various embodiments, links to recommendations, extras, media and/or artist information, related content, and so forth as described elsewhere within this Detailed Description.

The aforementioned techniques include a set of illustrative techniques for display of content on a home screen based on the likelihood of user selection. However other known techniques may be employed to accomplish similar results.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A computing device comprising:
one or more processors;
memory;
a display;
a user interface module stored on the memory and executable by the one or more processors to cause display of a home screen on the display, the home screen including an interactive list portion having graphical tiles associated with a subset of an ordered list of a plurality of media content items available to the computing device, the home screen including a user interface portion including at least one icon associated with one or more applications or linked to additional content relevant to one of the plurality of media content items that has user interface focus, the plurality of media content items including one or more of an electronic book, an audio content, a video content, a periodical content, or a web content; and
a prediction module stored in the memory and executable by the one or more processors to determine both the subset of the ordered list and an order for display of the subset of the ordered list based on at least recency data of the plurality of media content items, wherein the recency data includes one or more of a time of previous access, a time of purchase, or a time of download of the plurality of media content items.

2. The computing device of claim 1, wherein:
the user interface module is further configured to receive instructions associated with user input to display other graphical tiles associated with another subset of the ordered list of the plurality of media content items available to the computing device; and
the other subset of the ordered list having corresponding recency data indicating that individual ones of the other subset of the ordered list were accessed at different times than individual ones of the subset of the ordered list.

3. The computing device of claim 1, wherein an associated graphical tile of one of the plurality of media content items includes a graphical element showing a previously accessed percentage of one of the plurality of media content items.

4. A computing device comprising:
one or more processors;
memory;
a user interface module stored on the memory and executable by the one or more processors to cause display of a home screen of a user interface, the home screen including a subset of a list of a plurality of media content items available to the computing device; and
a prediction module stored on the memory and executable by the one or more processors to determine the subset of the list and an order for the display of the subset of the list based at least in part on a predicted likelihood that an individual one of the plurality of media content items will be selected.

5. The computing device of claim 4, wherein the user interface module is further executable to display the subset of the list as a plurality of graphical tiles that are associated with various ones of the plurality of media content items.

6. The computing device of claim 5, wherein:
at least one of the media content items is an aggregate of multiple media content items; and
one of the graphical tiles corresponding to the at least one of the media content items includes an aggregation mosaic.

7. The computing device of claim 4, wherein the user interface module is configured to receive instructions related to user input to cause display of additional ones of the plurality of media content items that are not included in the subset of the list.

8. The computing device of claim 7, wherein the user interface module is configured to display an animated transition from display of the subset of the list of the plurality of media content items to display of the additional ones of the plurality of media content items.

9. The computing device of claim 4, wherein the predicted likelihood is based, at least in part, on recency data associated with the individual one of the plurality of media content items.

10. The computing device of claim 9, wherein the recency data for a particular media content item includes one or more of a time of previous access, a time of purchase, or a time of download.

11. The computing device of claim 4, wherein at least one of the plurality of media content items is an application, an electronic book, a video file, blog content, web content, an electronic periodical, a music album, a television series, or a playlist.

12. The computing device of claim 4, wherein:
at least one of the plurality of media content items is another list of currently playing media content items; and
the predicted likelihood is based at least in part on how recently an addition has been made to the other list of currently playing media content items.

13. The computing device of claim 4, wherein:
the subset of the list is rendered in a first portion of the home screen; and
a second portion of the home screen includes another list of one or more applications.

14. The computing device of claim 4, wherein:
the subset of the list is rendered in a first portion of the home screen; and
a second portion of the home screen includes content associated with a particular media content item in the subset of the list that has user interface focus.

15. The computing device of claim 13, wherein the content associated with the particular media content item includes one or more of recommended media content items, a link to information associated with the particular media content item, or a link to information associated with an artist of the particular media content item.

16. The computing device of claim 4, wherein an associated graphical tile of one of the plurality of media content items displayed in the list includes a graphical element showing one or more of a percentage of the one of the plurality of media content items that has been downloaded, a portion of the one of the plurality of media content items that has been previously accessed, or a number of annotations made to the one of the plurality of media content items.

17. A method, comprising:
determining a display order of a plurality of media content items available to a computing device based at least in part on a predicted likelihood that an individual one of the plurality of media content items will be selected; and
displaying, within a home screen of the computing device according to the determined display order, an interactive list of the plurality of media content items.

18. The method of claim 17, wherein:
the interactive list includes a sliding window that determines a portion of the interactive list that is viewable on a display of the computing device at a particular time; and
the method further includes receiving instructions related to user input to slide the sliding window to a different location within the interactive list.

19. The method of claim 17, wherein the predicted likelihood is based on recency data associated with the individual one of the plurality of media content items.

20. The method of claim 17, wherein:
at least one of the plurality of media content items is a music file that is currently being played by the computing device; and
the predicted likelihood is based at least in part on how recently the music file or another music file has been added to another list of currently playing content media items.

21. The method of claim 17, further comprising displaying on the home screen additional content that is relevant to the particular one of the plurality of media content items, the displaying of the additional content in response to a particular one of the plurality of media content items having user interface focus.

22. The method of claim 17, further comprising displaying an associated graphical tile of one of the plurality of media content items in the interactive list, including displaying a graphical element showing one or more of a percentage of the one of the plurality of media content items that has been downloaded, a most recently accessed portion of the one of the plurality of media content items, or a rating of the one of the plurality of media content items.

23. One or more computer-readable storage media comprising a plurality of programming instructions executable by one or more processors to cause a computing device to:
render a home screen on a display of the computing device, the home screen including at least a portion of an ordered list of media content items that are available to the computing device, wherein a portion of the ordered list is viewable at a particular time; and
determine an order of the ordered list based at least in part on predicted likelihoods that individual ones of the media content items will be selected.

24. The one or more computer-readable storage media of claim 23, wherein the plurality of programming instructions are further executable to cause the computing device to render the ordered list as a plurality of graphical tiles associated with the individual ones of the media content items.

25. The one or more computer-readable storage media of claim 23, wherein the ordered list is interactive to cause other portions of the ordered list to be viewable.

26. The one or more computer-readable storage media of claim 23, wherein the plurality of programming instructions are further executable to cause the computing device to:
determine user interface focus for a particular one of the media content items; and
further render, on the home screen in response to the determination of user interface focus, additional information that is relevant to the particular one of the media content items.

27. The one or more computer-readable storage media of claim 26, wherein:
the particular one of the media content items is a playlist; and
the additional information is a currently-playing audio file.

28. The one or more computer-readable storage media of claim 23, wherein:
a particular one of the media content items is a newly available television episode; and
the predicted likelihoods are based at least on whether other episodes in a television series associated with the newly available television episode have been previously viewed.

29. The one or more computer-readable storage media of claim 23, wherein the plurality of programming instructions are further executable to cause the computing device to display an associated graphical tile of one of the plurality of media content items in the ordered list, including display of a synopsis of the one of the plurality of media content items that has been downloaded, a most recently accessed portion of the one of the plurality of media content items, or links to social media information associated with the one of the plurality of media content items.
